(19) United States
(12) Patent Application Publication
(10) Pub. No.: US 2016/0085429 A1
(43) Pub. Date: Mar. 24, 2016

(54) BEACON MANAGEMENT

(71) Applicant: ExactTarget, Inc., Indianapolis, IN (US)

(72) Inventor: Jonathon Christopher NEWBY, Fishers, IN (US)

(21) Appl. No.: 14/494,057

(22) Filed: Sep. 23, 2014

(51) Int. Cl. G06F 3/0484; G06F 3/0482; G06F 3/0486; G06F 3/0481

(52) U.S. Cl. CPC G06F 3/04847; G06F 3/0481; G06F 3/0482; G06F 3/04817; G06F 3/04842; G06F 3/0486

(57) ABSTRACT

Systems, devices, and techniques are disclosed for creating and configuring multiple beacons associated with a venue. A venue map is displayed, a first beacon is added to the venue map, a second beacon is added to the venue map, the first beacon and second beacon are configured, and a venue label is associated with the first beacon and the second beacon. The first beacon and the second beacon may be manipulated as a group.

### BACKGROUND

Conventionally, beacons are used to identify a mobile device's proximity to a location of a beacon. Information gathered by the beacon may be used for many purposes, such as pushing selective advertising based upon location to the mobile device. Configuring and maintaining large numbers of beacons and the information that they gather is an overwhelming challenge.

### BRIEF DESCRIPTION OF THE DRAWINGS

The accompanying drawings, which are included to provide a further understanding of the disclosed subject matter, are incorporated in and constitute a part of this specification. The drawings also illustrate embodiments of the disclosed subject matter and together with the detailed description serve to explain the principles of embodiments of the disclosed subject matter. No attempt is made to show structural details in more detail than may be necessary for a fundamental understanding of the disclosed subject matter and various ways in which it may be practiced.

FIG. 1 shows a beacon management system according to an embodiment of the disclosed subject matter.

FIG. 2 shows a flowchart according to an embodiment of the disclosed subject matter.

FIG. 3 shows a choose location type interface for choosing among three location types according to an embodiment of the disclosed subject matter.

FIG. 4 shows an interface for entering a venue address or a floorplan according to an embodiment of the disclosed subject matter.

FIG. 5 shows an uploaded floorplan according to an embodiment of the disclosed subject matter.

FIG. 6 shows a venue map according to an embodiment of the disclosed subject matter.

FIG. 7 shows a first beacon flyout for configuring the first beacon according to an embodiment of the disclosed subject matter.

FIG. 8 shows a second beacon flyout for configuring the second beacon according to an embodiment of the disclosed subject matter.

FIG. 9 shows a venue label and a populated beacon corral according to an embodiment of the disclosed subject matter.

FIG. 10 shows a large map in a location management interface according to an embodiment of the disclosed subject matter.

FIG. 11 shows a venue in a location management interface according to an embodiment of the disclosed subject matter.

### DETAILED DESCRIPTION

Configuring and maintaining large numbers of beacons and the information that they gather is an overwhelming challenge. In one embodiment, beacons may be created and configured while they are displayed on a venue map. During this creation and/or configuration, the beacons may be associated with the venue and/or with each other. In one embodiment, the venue may be a geographic location such as a store. In another embodiment, the venue may be a campaign.

The venue may be an address. A map API (Application Programming Interface), for example, for an online mapping service may be used to download a map associated with the address. Beacons may be added to the map (for example to specific locations of a building shown on the map) and represented visually by icons on the map. These added beacons may be configured using flyouts (windows that “fly out” or “pop up” when a pointer (of a mouse or a trackball) clicks on or hovers over an active area associated with a beacon icon), so that the location of the beacon being configured may be visually shown on the map during the configuration through the flyout. Thus, the beacons may be configured while they are “on-map” (while they are being displayed on the map at their exact location). The term “flyout” is used in the specification and claims in a broad sense, as any graphical interface for configuring a beacon while simultaneously indicating, on the map, the location of the beacon that is being configured.

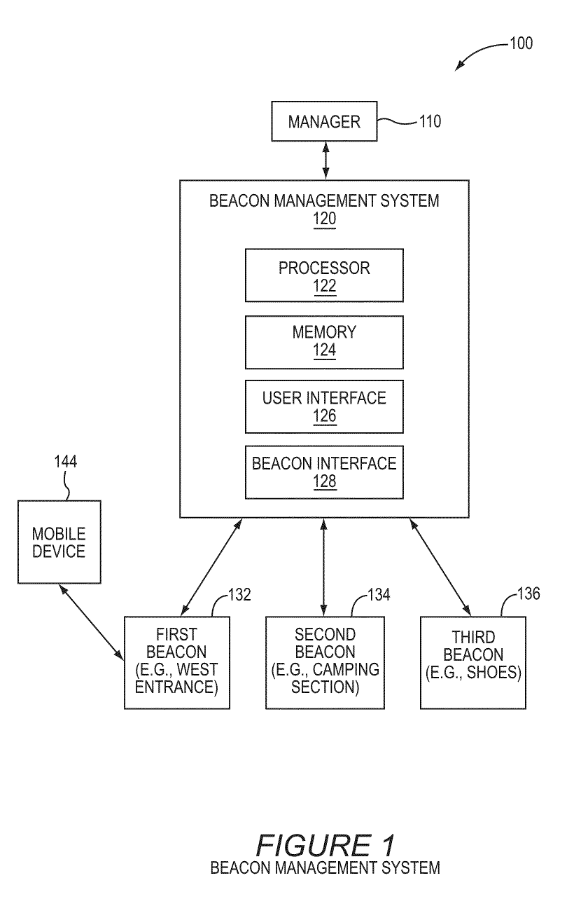

FIG. 1 shows a beacon management configuration 100 according to an embodiment of the disclosed subject matter. A manager 110 (a.k.a. a user or a marketer) interacts with beacon management system 120 to create and configure beacons 132, 134, and 136.

Beacon management system 120, in a simple embodiment, may be a single personal computer including: a processor 122, a memory 124, a user interface 126, and a beacon interface 128.

In another embodiment, the elements of beacon management system 120 may be scattered at various diverse locations, and may communicate through the Internet and/or through mobile communication systems. For example, processor 122 may be located in manager mobile device (not shown) held in the hands of manager 110. Memory 124 may include computer readable storage media in the manager's mobile device, and may include additional computer readable storage media such as a database (not shown) located in an underground cave for security. User interface 126 may include (not shown) a keyboard, a mouse, a display, and a microphone (for voice commands). Beacon interface 128 may include (not shown) an Internet connection, a land phone connection, and a mobile phone connection.

For example, first beacon 132 may be located at the west entrance of a store. Second beacon 134 may be located at the camping section of the store, and third beacon 136 may be located at the shoe section of the store.

First beacon 132 identifies mobile device 144 as being in proximity to first beacon 132. First beacon 132 may pass this information to beacon management system 120, and may receive instructions from beacon management system 120 to push an advertisement for shoes to mobile device 144. Bluetooth standards may be used to communicate with mobile device 144.

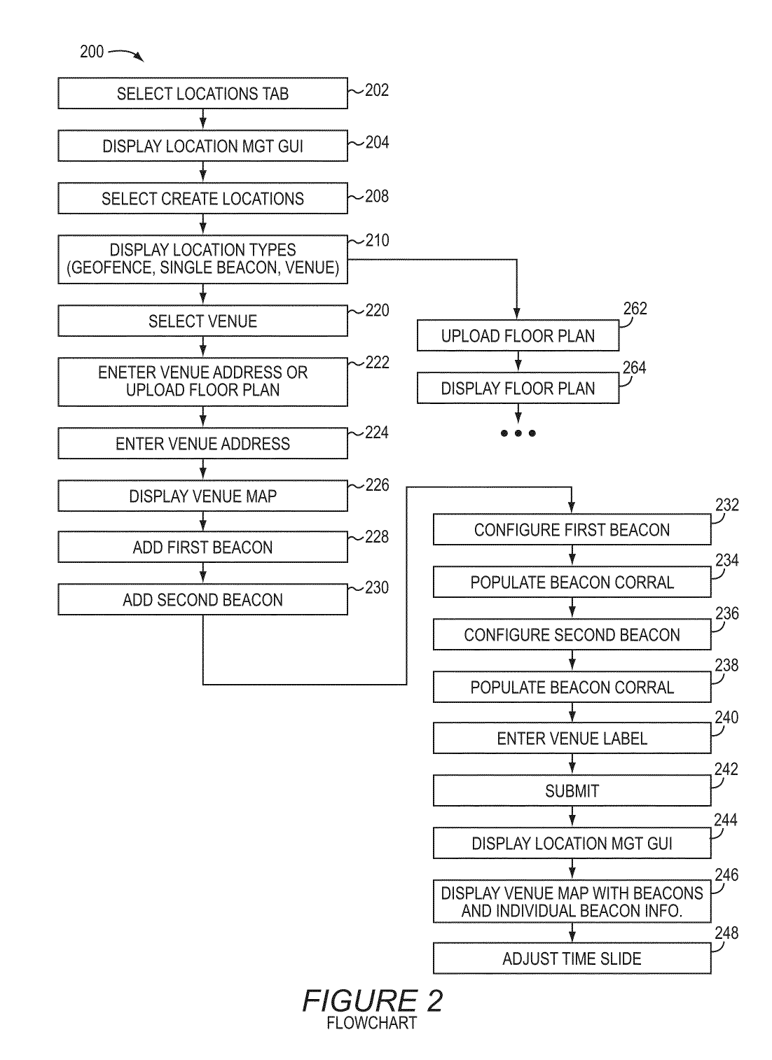

FIG. 2 shows a flowchart 200 according to an embodiment of the disclosed subject matter. Flowchart 200 illustrates the major steps of one embodiment. Substantial additional detail is provided in later figures.

In step 202, a manager selects a location tab on a graphical user interface in order to access a location management interface. Step 204 displays a location management interface.

In step 208, a manager 110 selects an option to create locations. Three types of locations (geofence, single beacon, and venue) are displayed in step 210 for selection. Venue may be selected as the location type at step 220.

Step 222 provides a selection for either entering a venue address or uploading a floorplan. If the manager selects to upload a floorplan, then a floorplan may be uploaded at step 262. A floorplan may be any kind of visual representation that may be meaningful to the manager and will help the manager to document where the beacons are deployed. For example, a floorplan may be a photograph, a blueprint, a hand drawing, etc. The floorplan may be displayed at step 264. Beacons may be added to the floorplan and may be configured (these steps are not shown).

Returning to step 222, if the manager decides to enter a venue address, then the manager enters the venue address at step 224. Step 226 displays the venue map. The venue map may be obtained from Google Maps. The manager may resize and reposition the venue map for convenience and clarity before adding beacons.

Step 228 adds the first beacon to the venue map. The first beacon may be added by clicking and dragging a beacon icon onto the venue map. Step 230 adds a second beacon in a similar fashion.

Step 232 configures the first beacon. At step 234, configuration of the first beacon may automatically populate a beacon corral with a name of the first beacon.

Step 236 configures the second beacon. At step 238, configuration of the second beacon may automatically populate the beacon corral with a name of the second beacon.

At step 240, the manager enters a venue label, and submits the configured beacons at step 242. Upon submission, the beacon management system may return to and display the location management graphical user interface (updated with the new beacons) at step 244.

Step 246 displays the venue map with beacons, and displays individual beacon information adjacent to each individual beacon respectively.

At step 248, the manager may adjust a time slide icon to change the period of time that may be being reported by the beacons (e.g., reported by an individual display of information adjacent to each beacon). For example, the time slide may be set to include only the previous fifteen minutes or may be set to include only the most recent hour. The displayed individual displayed information for all beacons in a venue may change if the time slide setting is altered.

Flowchart 200 is exemplary, and generally steps may be added, omitted, or reordered. For example, steps 228, 230, 232, 234, 236, and 238 may be reordered such that the first beacon may be configured before the second beacon may be added (228, 232, 234, 230, 236, and 238). Also, populating the beacon corral may be delayed until after all configurations are complete (228, 230, 232, 236, 234, and 238). Populating the beacon corral may be delayed until after the venue label is entered (240, 234, and 238). Populating the beacon corral (234 and 238) may be omitted from one embodiment.

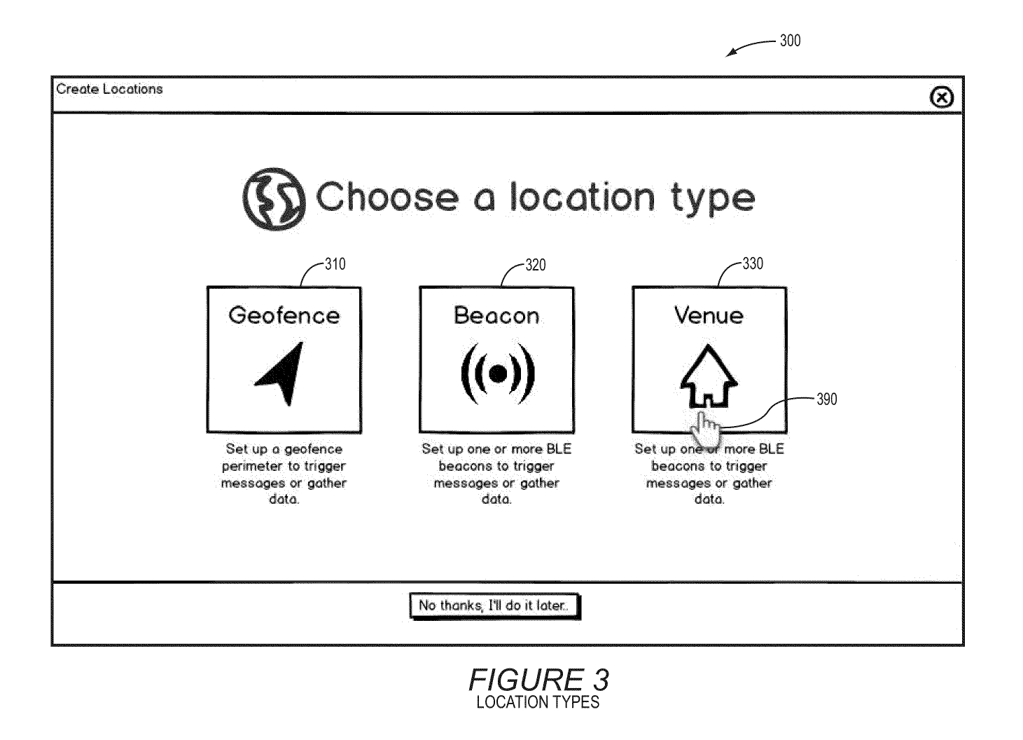

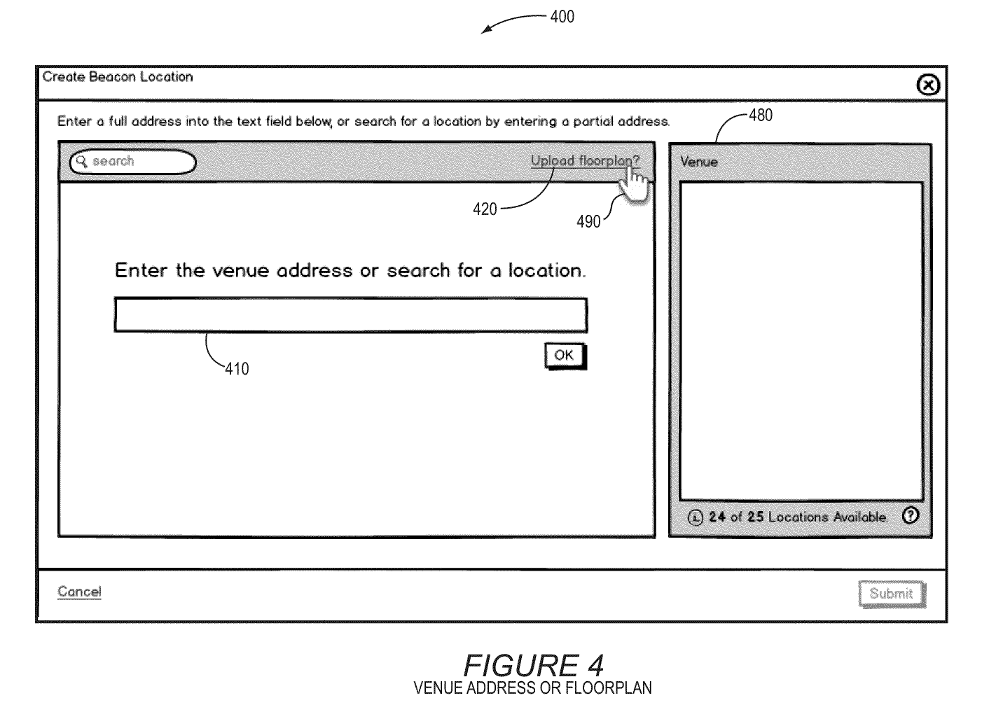

FIG. 3 shows a choose location type interface 300 for choosing among three location types according to an embodiment of the disclosed subject matter. The three location types are geofence 310, beacon 320, and venue 330. The manager may select venue 330 using pointer 390 to display interface 400 of FIG. 4, as discussed below.

FIG. 4 shows an interface 400 for entering a venue address or a floorplan according to an embodiment of the disclosed subject matter. Any existing venue information may be displayed in venue window 480 (blank in FIG. 4). The manager may enter a venue address into window 410, or may select “Upload Floorplan?” 420 with pointer 490 to upload a floorplan.

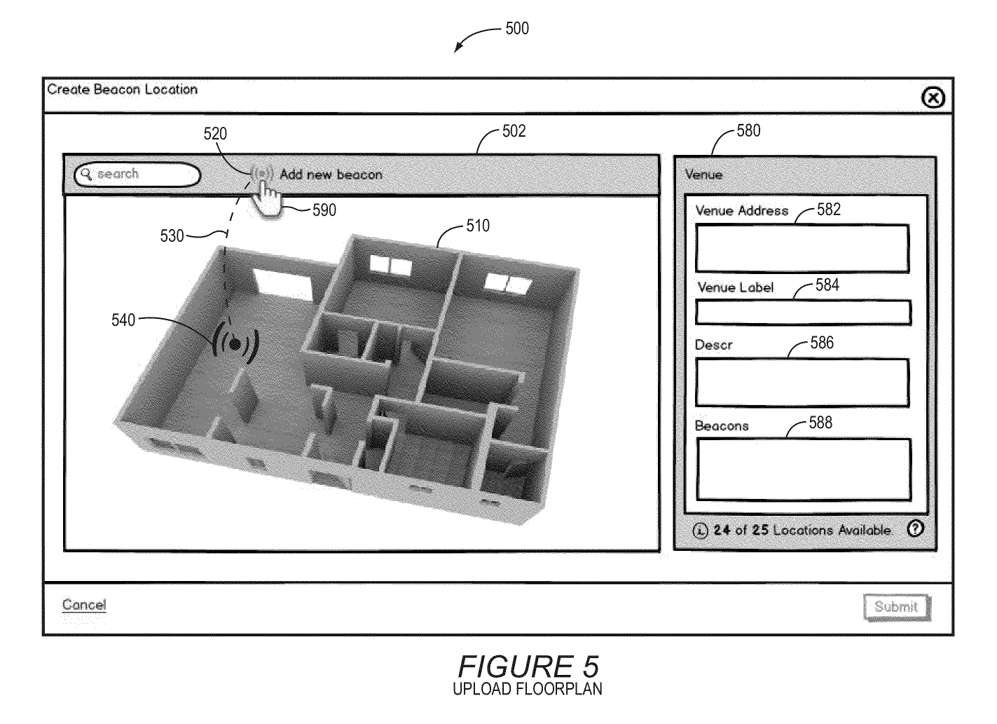

FIG. 5 shows an interface 500 including uploaded floorplan 510 in floorplan window 502 according to an embodiment of the disclosed subject matter. Venue window 580 may remain empty until at least one beacon is added and configured.

The manager may use pointer 590 to click and drag a new beacon icon 520 across path 530 to new beacon location 540. Venue window 680 may include fields for venue address 582, venue label 584, description 586, and beacon corral 588.

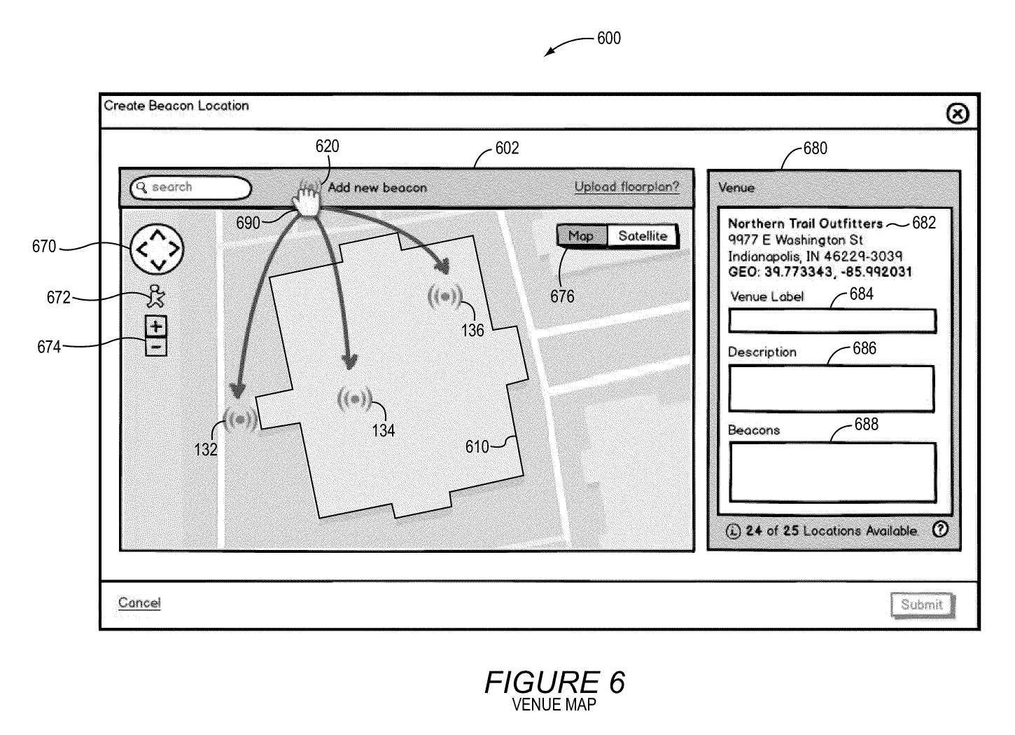

FIG. 6 shows a venue map 610 according to an embodiment of the disclosed subject matter. Interface 600 includes map window 602 and venue window 680. Map window 602 includes “add new beacon” icon 620, venue map 610 (e.g., a building outline downloaded from Google Maps, including the adjacent area), and interface icons 670, 672, 674, and 676.

Pointer 690 may be used to click and drag from “add new beacon” icon 620 to create and to position first beacon 132 (as shown by the leftmost arrow). Similarly, the manager may click and drag to create and position second beacon 134, and click and drag to create and position third beacon 136.

Venue window 680 may be relatively empty, with only venue address 682 providing information (Northern Trail Outfitters, etc.). The fields for venue label 684, description 686, and beacon corral 688 are empty.

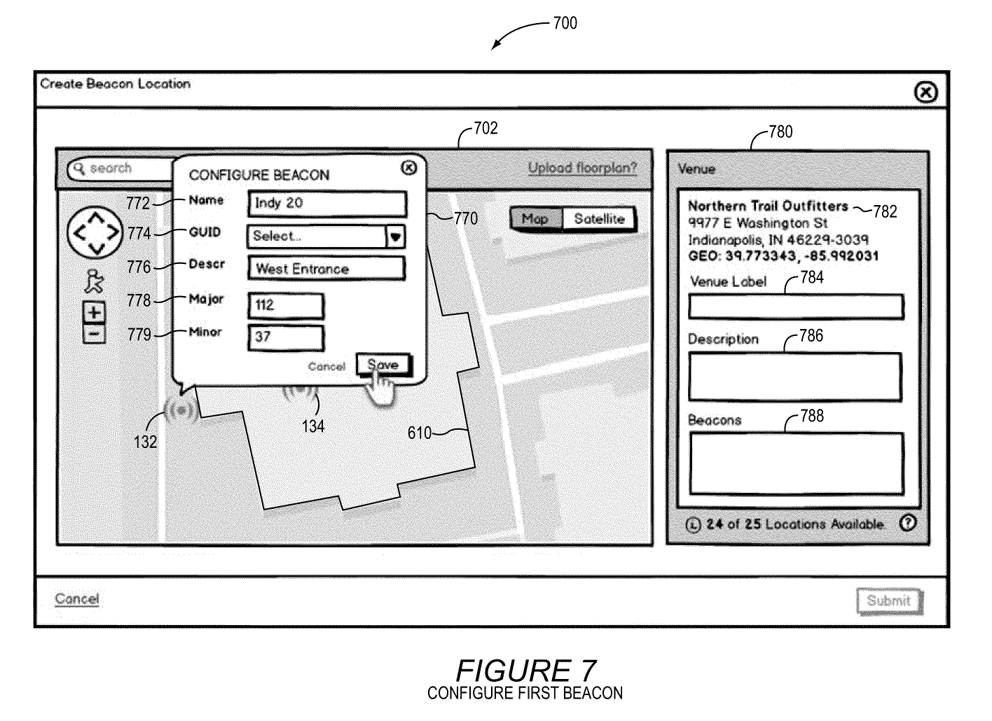

FIG. 7 shows a first beacon flyout 770 for configuring the first beacon according to an embodiment of the disclosed subject matter. Interface 700 includes map window 702 and venue window 780. Map window 702 may be similar to map window 602 of FIG. 6, except that first beacon flyout 770 may be displayed. First beacon flyout 770 points (like a conversational balloon in a cartoon) to first beacon 132 to visually indicate which beacon it will configure. Other methods of visual indication may be used.

First beacon flyout 770 provides field 772 for inputting a beacon name (e.g., Indy 20), field 774 for a GUID (Globally Unique Identifier), field 776 for a description (West Entrance), field 778 for a major number (112) and field 779 for a minor number (37). After filling some or all of the first beacon flyout 770 fields, the manager may click on the “Save” icon to save the information, thus configuring the first beacon.

Venue window 780 may be relatively empty, with only venue address 782 providing information (Northern Trail Outfitters, etc.). The fields for venue label 784, description 786, and beacon corral 688 are empty.

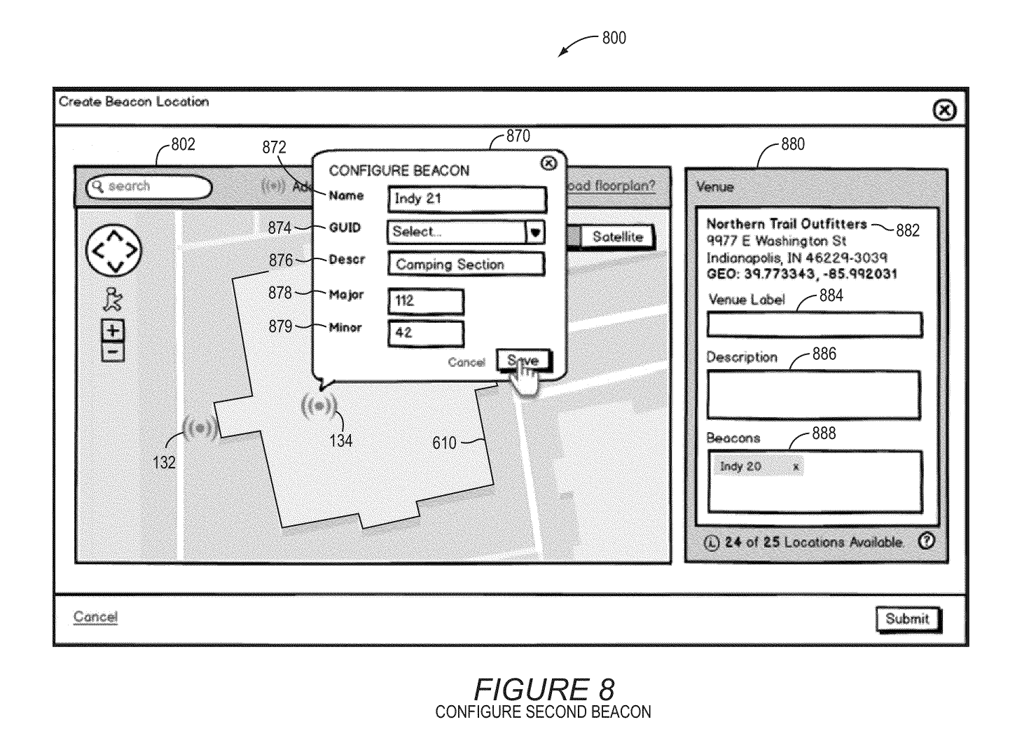

FIG. 8 shows a second beacon flyout 870 for configuring second beacon 134 according to an embodiment of the disclosed subject matter. As a preliminary matter, note that beacon corral 888 may be populated with the name “Indy 20” of first beacon 132, due to the configuration (including naming) of first beacon 132 as discussed above with respect to FIG. 7.

Interface 800 includes map window 802 and venue window 880. Map window 802 may be very similar to map window 702 of FIG. 7, except that second beacon 134 may now being configured through second beacon flyout 870.

Second beacon flyout 870 provides field 872 for inputting a beacon name (e.g., Indy 21), field 874 for a GUID (Globally Unique Identifier), field 876 for a description (Camping Section), field 878 for a major number (112) and field 879 for a minor number (42). After filling the second beacon flyout 870 fields, the manager may click on the “Save” icon to save the information, thus configuring the second beacon.

Venue window 880 includes a venue address 882, a field for venue label 884, a field for description 886, and beacon corral 888 (populated by the first beacon name “Indy 20”).

If the manager clicks on the “Save” icon in second beacon flyout 870, then second beacon 134 will be configured according to second beacon flyout 870, and beacon corral 888 will be additionally populated by the second beacon name “Indy 21” (not shown).

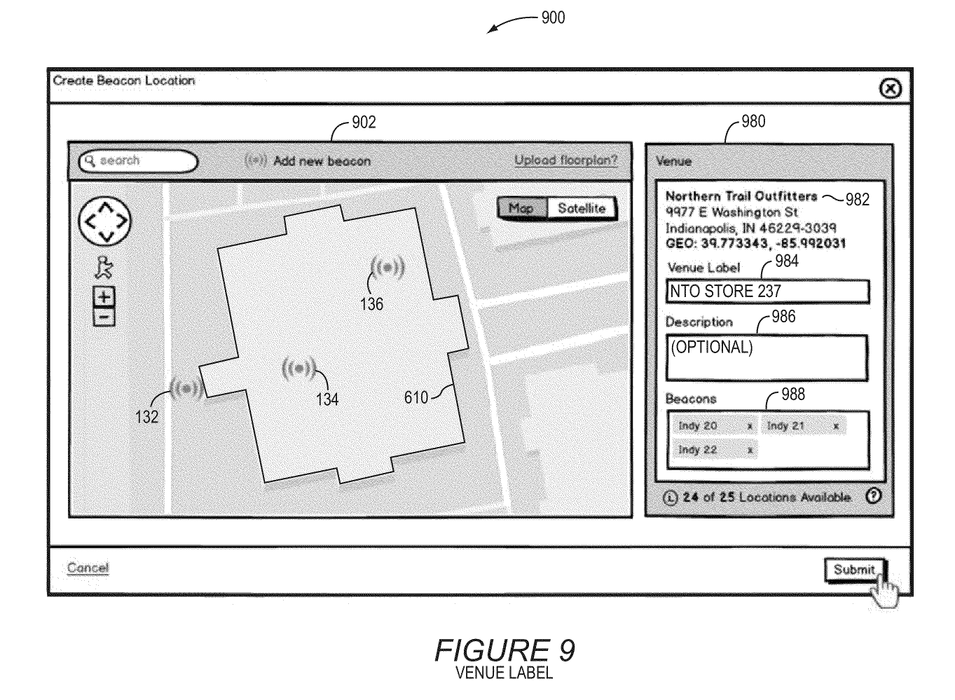

FIG. 9 shows a venue label 984 and a populated beacon corral 988 according to an embodiment of the disclosed subject matter. Interface 900 includes map window 902 and venue window 980. Map window 902 includes map 610, first beacon 132, second beacon 134, and third beacon 136.

Venue window 980 includes address 982, a field for venue label 984 (NTO Store 237), a field for description 986 (optional), and beacon corral 988 populated by three names: Indy 20, Indy 21, and Indy 22, corresponding respectively to first beacon 132, second beacon 134, and third beacon 136. Thus, a third beacon flyout (not shown) was previously populated by the manager to configure the third beacon 136. These three beacons may be associated with the venue, and/or the venue label, and/or may be associated with each other.

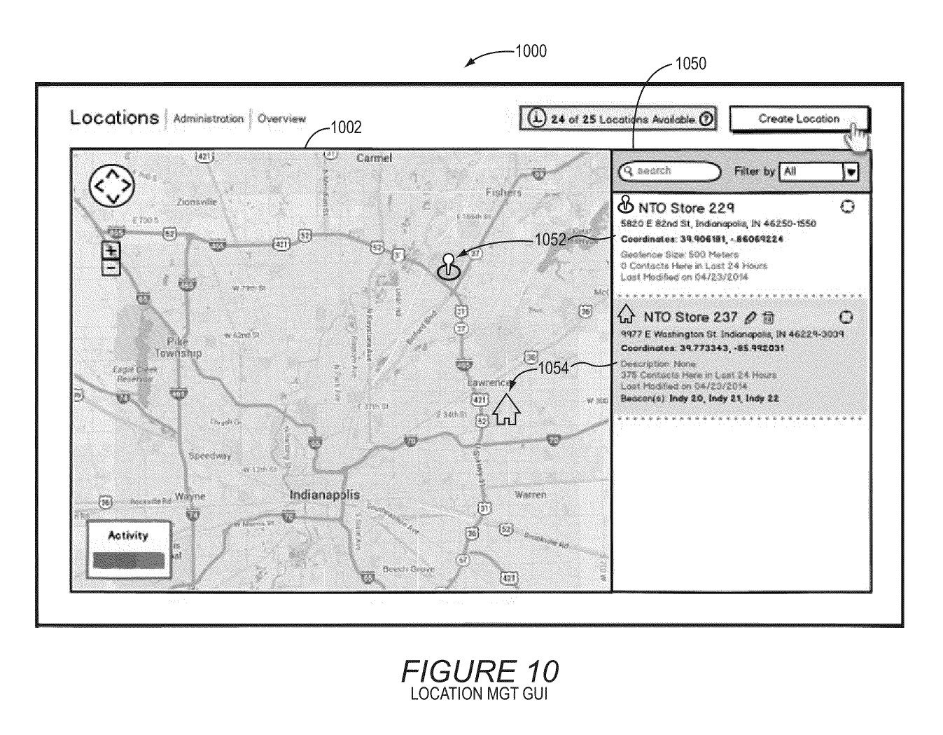

FIG. 10 shows a location management interface 1000 including a large map 1002 and a location window 1050 in according to an embodiment of the disclosed subject matter.

Location window 1050 lists two locations: location 1052 and location 1054. Location 1052 may be a geofence type location, and may be labeled (named) NTO Store 229. Location 1054 may be a venue type location, may be labeled (named) NTO Store 237 and includes first beacon 132, second beacon 134, and third beacon 136.

Large map window 1002 shows a geofence icon (shaped like a pushpin in a circle) corresponding to the location of NTO Store 229.

Large map window 1002 also shows a venue icon (shaped like a house) corresponding to the location of NTO Store 237 (with beacons Indy 20, Indy 21, and Indy 22). A manager may click on the venue icon in large map 1002 to display the venue map associated with the venue icon.

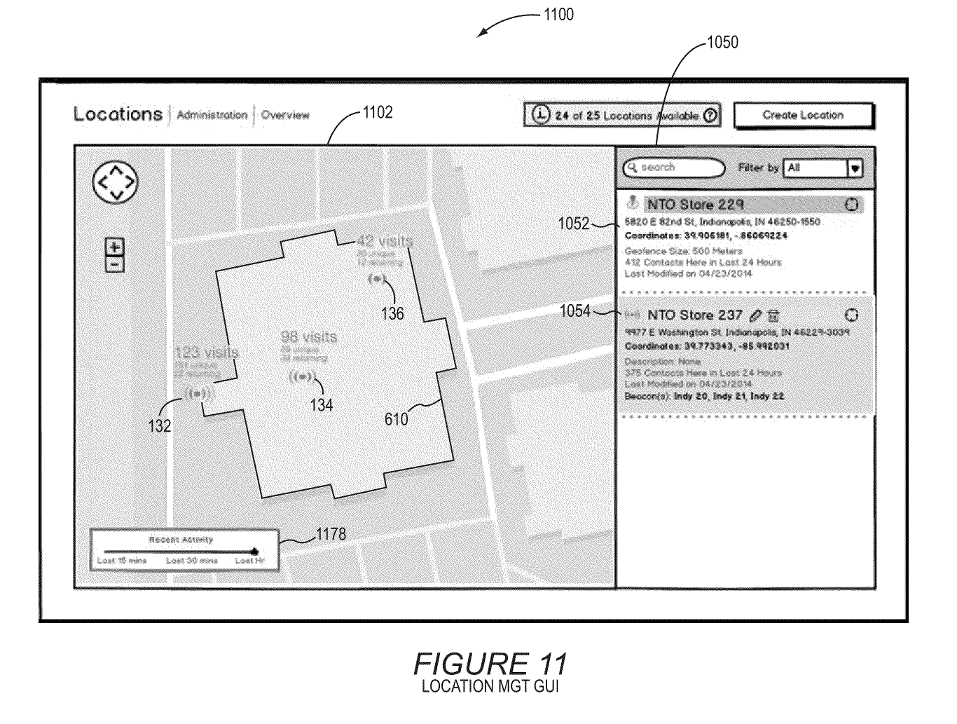

FIG. 11 shows a location management interface 1100 including a map window 1102, and a location window 1050 according to an embodiment of the disclosed subject matter.

Map window 1102 include venue map 610, first beacon 132, second beacon 134, third beacon 136, and time slide 1178. Time slide 1178 selects the amount of time (from fifteen minutes to one hour) used for determining recent activity. Recent activity of each beacon may be displayed adjacent to each beacon. For example, first beacon 132 had 123 visits in the last hour.

If time slide 1178 is adjusted, then recent activity of the beacons in this venue may be recalculated and redisplayed. In this fashion, all beacons of a venue may be easily viewed and easily manipulated simultaneously.

Location window 1050 displays aggregate information for the venue NTO Store 237, such as “375 Contacts Here in Last 24 Hours.”

In this fashion, multiple beacons for single venue may be created and configured on a small/local map (per FIGS. 6-9), may be viewed as a single group (NTO Store 237 in FIG. 10) on a large/global map (NTO Store 237 in FIG. 10), and may be simultaneously manipulated (e.g., by time slide 1178 in FIG. 11).

More generally, various embodiments of the presently disclosed subject matter may include or be embodied in the form of computer-implemented processes and apparatuses for practicing those processes. Embodiments also may be embodied in the form of a computer program product having computer program code containing instructions embodied in non-transitory and/or tangible media, such as floppy diskettes, CD-ROMs, hard drives, USB (universal serial bus) drives, or any other machine readable storage medium, such that when the computer program code is loaded into and executed by a computer, the computer becomes an apparatus for practicing embodiments of the disclosed subject matter. Embodiments also may be embodied in the form of computer program code, for example, whether stored in a storage medium, loaded into and/or executed by a computer, or transmitted over some transmission medium, such as over electrical wiring or cabling, through fiber optics, or via electromagnetic radiation, such that when the computer program code is loaded into and executed by a computer, the computer becomes an apparatus for practicing embodiments of the disclosed subject matter. When implemented on a general-purpose microprocessor, the computer program code segments configure the microprocessor to create specific logic circuits.

In some configurations, a set of computer-readable instructions stored on a computer-readable storage medium may be implemented by a general-purpose processor, which may transform the general-purpose processor or a device containing the general-purpose processor into a special-purpose device configured to implement or carry out the instructions. Embodiments may be implemented using hardware that may include a processor, such as a general purpose microprocessor and/or an Application Specific Integrated Circuit (ASIC) that embodies all or part of the techniques according to embodiments of the disclosed subject matter in hardware and/or firmware. The processor may be coupled to memory, such as RAM, ROM, flash memory, a hard disk or any other device capable of storing electronic information. The memory may store instructions adapted to be executed by the processor to perform the techniques according to embodiments of the disclosed subject matter.

The foregoing description, for purpose of explanation, has been described with reference to specific embodiments. However, the illustrative discussions above are not intended to be exhaustive or to limit embodiments of the disclosed subject matter to the precise forms disclosed. Many modifications and variations are possible in view of the above teachings. The embodiments were chosen and described in order to explain the principles of embodiments of the disclosed subject matter and their practical applications, to thereby enable others skilled in the art to utilize those embodiments as well as various embodiments with various modifications as may be suited to the particular use contemplated.

1. A beacon management system comprising:
a processor, and
a computer readable storage media including instructions that, when executed, cause the processor to:
display a venue map;
add a first beacon at a first location on the venue map upon receiving a first command from a user;
add a second beacon at a second location on the venue map upon receiving a second command from the user;
receive first configuration information including a first beacon name for the first beacon;
receive second configuration information including a second beacon name for the second beacon;
receive a venue label from the user; and
associate the venue label with the first beacon and with the second beacon.

2. The beacon management system of claim 1, wherein the instructions further cause the processor to:
display a set of location types, wherein the set of location types includes geofence, single beacon, and venue;
receive a location type command from the user selecting venue.

3. The beacon management system of claim 1, wherein the first command includes a drag and drop operation of a first beacon icon onto the first location of the venue map to add the first beacon at the first location.

4. The beacon management system of claim 1, wherein the first configuration information is received through a first flyout that is displayed on the venue map upon selection of the first beacon.

5. The beacon management system of claim 4, wherein the first flyout includes a first name field, a first global unique identifier (GUID) field, a first description field, a first major number field, and a first minor number field.

6. The beacon management system of claim 1, wherein second configuration information is received through a second flyout that is displayed on the venue map upon selection of the second beacon.

7. The beacon management system of claim 6, wherein the second flyout includes a second name field, a second global unique identifier (GUID) field, a second description field, a second major number field, and a second minor number field.

8. The beacon management system of claim 1, wherein the instructions further cause the processor to:
populate a beacon corral with the first beacon name; and
populate the beacon corral with the second beacon name.

9. The beacon management system of claim 1, wherein the instructions further cause the processor to:
display the venue on a large map.

10. The beacon management system of claim 9, wherein the instructions further cause the processor to:
display the venue map;
display, on the venue map, the first beacon and activity of the first beacon over a first period of time; and
display, on the venue map, the second beacon and activity of the second beacon over the first period of time.

11. The beacon management system of claim 10, wherein the instructions further cause the processor to:
change the first period of time into a second period of time in response to a single command for all beacons associated with the venue;
display, on the venue map, the first beacon and activity of the first beacon over the second period of time; and
display, on the venue map, the second beacon and activity of the second beacon over the second period of time.

12. The beacon management system of claim 11, wherein the instructions further cause the processor to:
display venue information including at least one summary of activity occurring at each individual beacon associated with the venue.

13. A method for managing beacons, the method comprising:
displaying a venue map;
adding a first beacon at a first location on the venue map upon receiving a first command from a user;
adding a second beacon at a second location on the venue map upon receiving a second command from the user;
receiving first configuration information including a first beacon name for the first beacon;
receiving second configuration information including a second beacon name for the second beacon;
receiving a venue label from the user; and
associating the venue label with the first beacon and with the second beacon.

14. A computer readable storage media including instructions that, when executed by a processor, cause the following actions to occur:
display a venue map;
add a first beacon at a first location on the venue map upon receiving a first command from a user;
add a second beacon at a second location on the venue map upon receiving a second command from the user;
receive first configuration information including a first beacon name for the first beacon;
receive second configuration information including a second beacon name for the second beacon;
receive a venue label from the user; and
associate the venue label with the first beacon and with the second beacon.
